(19) United States
(12) Patent Application Publication
(10) Pub. No.: US 2012/0019681 A1
(43) Pub. Date: Jan. 26, 2012

(54) MULTI-FUNCTION TELECOM AND NETWORK CAMERA

(76) Inventors: KUO-LIANG CHEN, Taipei (TW); Hsiang-Chiao Chen, Taipei (TW); Yu-An Chen, Taipei (TW); Yu-Ming Chen, Taipei (TW)

(21) Appl. No.: 12/841,182

(22) Filed: Jul. 22, 2010

(51) Int. Cl. H04N 5/232

(52) U.S. Cl. 348/211.1; 348/E05.042

(57) ABSTRACT

A multi-function telecom and network camera includes front case, at least one camera component, control unit, and a rear case. The camera component and the control unit are arranged between the front case and the rear case. A sensor unit, receiver, and at least one motion unit are also included. The sensor unit is arranged to the front case for activating the camera component. The receiver is arranged to the control unit for receiving signal so as to control the motion unit through the control unit. Through above components, a remote monitoring through IP (Internet protocol) address and 3G cell phone can be achieved. A zooming-in, zooming-out, horizontal rotation, and inclination of the camera can be performed by the cell phone.

### FIELD OF THE INVENTION

The present invention relates to camera, and particular to a multi-function telecom and network camera.

### DESCRIPTION OF THE PRIOR ART

The invention of the present inventor disclosed a camera device which is formed by a front case, rear case, camera component, and a control unit. The camera component and the control unit are arranged between the front case and the rear case. A cover is arranged to the front case to protect the camera component and an infrared LED. A SIM card slot, power connector, network cable connector, and an antenna are arranged to the rear case. Through an internet protocol address provided by a 3G telecom provider, users could receive image and message instead of through the telecom network.

A prior network camera has following disadvantages. 1. A delay of image and voice will happen through the telecom network. 2. Prior network camera is fixed so that the monitoring area is limited. 3. Prior network camera is manual activation. It's hard to perform a full time monitoring for unpredictable events.

### SUMMARY OF THE PRESENT INVENTION

Accordingly, the primary object of the present invention is to provide a multi-function telecom and network camera including a front case, at least one camera component, control unit, and a rear case. The camera component and the control unit are arranged between the front case and the rear case. A sensor unit, receiver, and at least one motion unit are also included. The sensor unit is arranged to the front case for activating the camera component. The receiver is arranged to the control unit for receiving signal so as to control the motion unit through the control unit. Through above components, a remote monitoring through IP (Internet protocol) address and 3G cell phone can be achieved. A zooming-in, zooming-out, horizontal rotation, and inclination of the camera can be performed by the cell phone.

### BRIEF DESCRIPTION OF THE DRAWINGS

FIG. 1 is an exploded view of the present invention.

FIG. 2 is a schematic view of the present invention.

FIG. 3 is a rear view of the present invention.

FIG. 4 is a schematic view showing a horizontal rotation of the present invention.

FIG. 5 is a schematic view showing a inclined motion of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

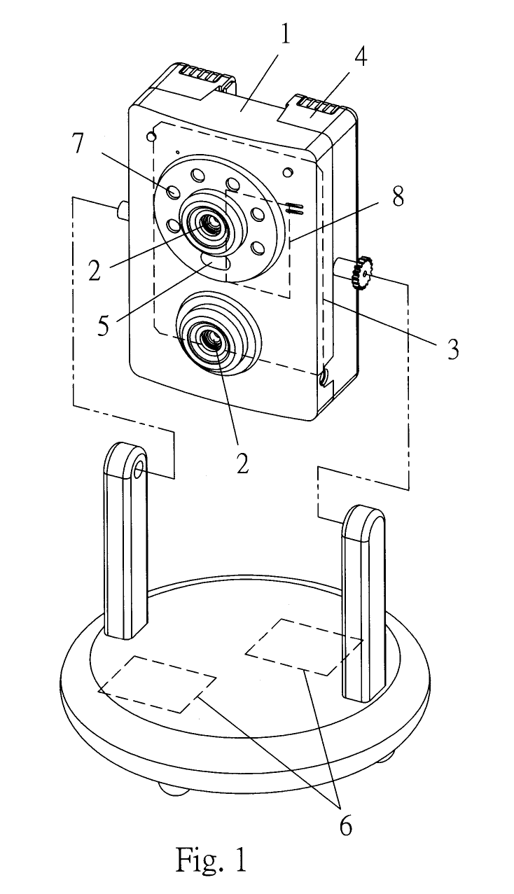

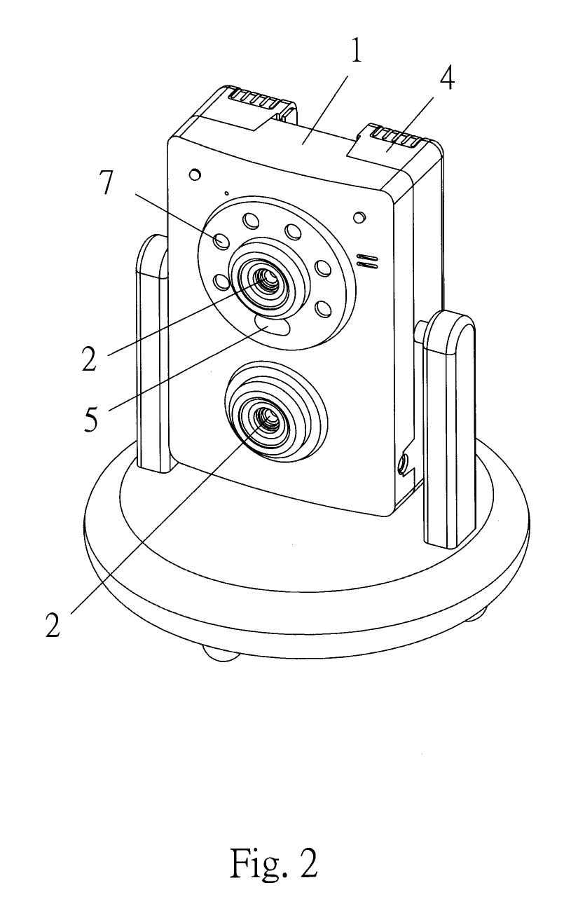

Referring to FIGS. 1 and 2, a multi-function telecom and network camera according to the present invention is illustrated. The camera has a front case 1, at least one camera component 2, control unit 3, and a rear case 4. The front case 1 has at least one cover and at least one infrared LED 7. The camera component 2 and the control unit 3 are arranged between the front case 1 and the rear case 4. A sensor unit 5, receiver, and at least one motion unit 6 are also included. The sensor unit 5 is arranged to the front case 1 for activating the camera component 2. The receiver is arranged to the control unit 3 for receiving signal so as to control the motion unit 6 through the control unit 3. A chargeable battery 8 is arranged to the control unit 3 for supplying power. Through above components, a remote monitoring through IP (Internet protocol) address and a 3G cell phone can be achieved. A zooming-in, zooming-out, horizontal rotation, and inclination of the camera can be controlled by the cell phone.

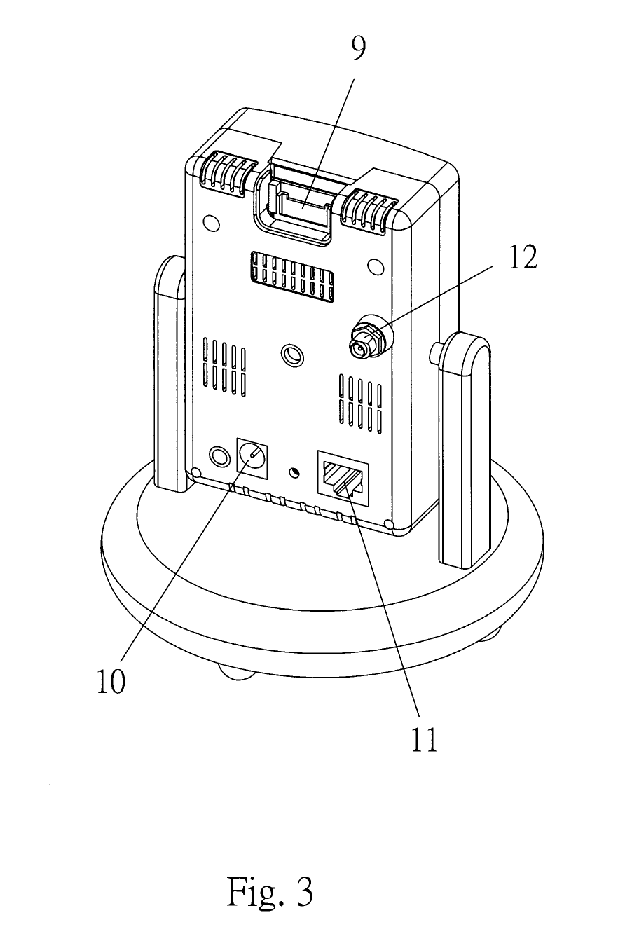

Referring to FIG. 3, a SIM card slot 9, power connector 10, network cable connector 11, and an antenna 12 are arranged to the rear of the camera. The power connector 10 serves to connect to a power for operations, and the chargeable battery 8 can be charged too. Through the SIM card slot 9 and the antenna 12, the function of remote monitoring through a 3G cell phone can be achieved. While the remote monitoring through IP address is through the network cable connector 11.

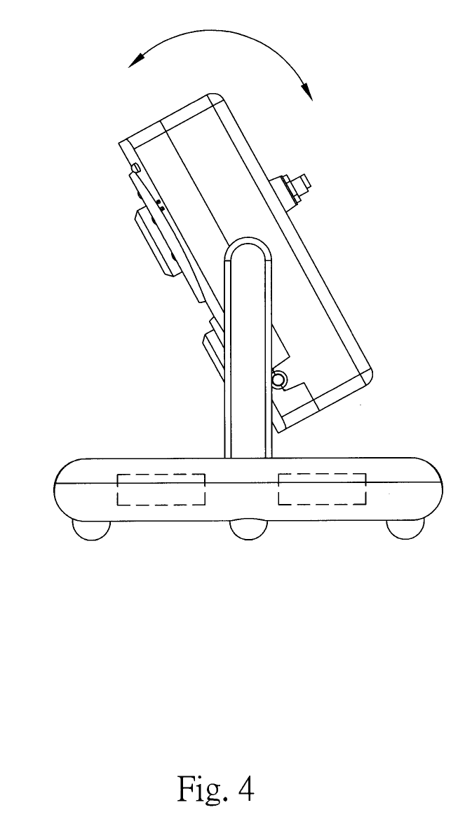

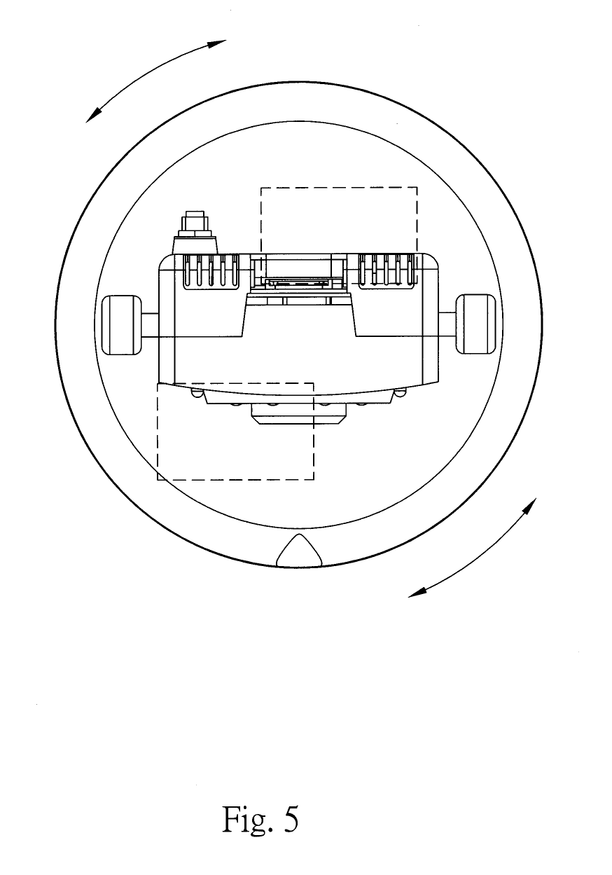

Moreover, referring to FIGS. 1, 4, and 5, the horizontal rotation and inclination of the camera can be performed by the motion unit 6 through a remote control of the cell phone.

Advantages of the present invention are listed in the following.

1. The present invention can transfer voice and video through network and also through the 3G cell phones so that a delay of voice or image will not happen by the network.

2. The motion of the present invention can be remote controlled through a cell phone so as to have a proper and clear monitoring.

3. The present invention can be activated by thermal detection. The monitoring will be activated automatically by an event so that a full time monitoring can be achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-function telecom and network camera comprising:
at least one camera component arranged between a front case and a rear case;
a control unit arranged between the front case and the rear case;
a sensor unit arranged to the front case for activating the camera component;
at least one motion unit performing rotation;
a receiver receiving a signal for controlling motion unit through the control unit;
wherein the multi-function telecom and network camera has function of remote monitoring through internet protocol address and 3G cell phone; motions of zooming in, zooming out, horizontal rotation, and inclination is controlled by cell phone.

2. The multi-function telecom and network camera as claimed in claim 1, wherein at least one cover and at least one infrared LED are arranged to the front case.

3. The multi-function telecom and network camera as claimed in claim 1, wherein a chargeable battery is arranged to the control unit.

4. The multi-function telecom and network camera as claimed in claim 1, wherein a SIM card slot, power connector, network cable connector, and an antenna are arranged to the rear case.

5. The multi-function telecom and network camera as claimed in claim 1, wherein the sensor unit is a thermal detector.

6. The multi-function telecom and network camera as claimed in claim 1, wherein the motion unit performs a 360 degrees motion.

7. The multi-function telecom and network camera as claimed in claim 6, wherein an inclination is performed by the motion unit.
